(19) United States
(12) Patent Application Publication
(10) Pub. No.: US 2007/0067806 A1
(43) Pub. Date: Mar. 22, 2007

(54) Provision of broadcast network services

(76) Inventors: Stephen Grant Russell, San Francisco, CA (US); David Bukhan, Palo Alto, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/601,119

(22) Filed: Nov. 16, 2006

Related U.S. Application Data
(63) Continuation of application No. 09/916,138, filed on Jul. 25, 2001.
(60) Provisional application No. 60/220,827, filed on Jul. 26, 2000.

(51) Int. Cl. H04N 5/445; G06F 13/00; G06F 3/00; H04N 7/173; H04H 9/00; H04N 7/16

(52) U.S. Cl. 725/61; 725/114; 725/117; 725/52; 725/60; 725/14

(57) ABSTRACT

A method for providing broadcast network services from a server by providing a broadcaster with access to an application tool, a storage device, and a streaming media tool bundled together so the broadcaster can create, upload and/or store program files using the application tools, transmit the program file to the members as streaming media, and also allow the member to download auxiliary files associated with the program file, rate the content of the program file, and/or send communications to the broadcaster related to the program file.

### RELATED APPLICATIONS/PRIORITY CLAIM

This application claims the benefit of the filing date of provisional application Ser. No. 60/220,827, filed Jul. 26, 2000, the entire disclosure of which is hereby incorporated.

### BACKGROUND OF THE INVENTION

1. Field of the Invention

The present invention relates generally to the provision of broadcast network services. Broadcast networks are systems for providing content to end users such as viewers from one or more dissemination points over a communication network such as a network linking computers. Broadcast network services provide the tools and facilities used to create, upload, and disseminate rich-media content.

2. Description of the Background Art

Broadcast network service facilities include application tools, storage devices, and streaming technologies. Broadcast network service facilities have traditionally been custom creations in which a broadcaster who desired to broadcast content to a group of end users would acquire and implement the application tools, storage devices, and streaming technologies, as needed, from among the resources available at the time. Thus, application tools, storage devices and streaming technologies were customarily purchased separately by a broadcaster, who integrated and maintained them. Such a broadcast network is herein denominated an Internet Broadcast Network (IBN). Such custom-built IBNs require a significant amount of time to develop and deploy.

Although storage devices and streaming technologies have recently become available on a time-share or bundled basis from various providers, an integrated, unified solution has heretofore not been available. A content provider, for example, might own the application tools but lease storage devices and streaming technologies from service providers. In addition, considerable fixed costs are entailed in developing application tools to work with storage devices and streaming technologies. A broadcaster who desires to broadcast over a network would thus face the task of assembling the required tools and facilities from a disparate mix of available tools, integrating them so they functioned smoothly and efficiently together as a system, debugging the system, and keeping the system up and operating throughout the broadcast. Building an IBN from a diverse assemblage of technologies, and designing a system wherein the technologies function together in a smooth and efficient manner can be a difficult task, as one of skill in the art will be aware. Although technologies like software and hardware are ostensibly built to standards that ensure reliable collective functioning, porting software to specific hardware, for example, often poses unforeseen problems, and may require significant testing, debugging and re-work. And even if the software works with the respective hardware, it may not work as efficiently as a standardized and tested system that was built with collective functionality in mind. Also, the choice of the particular format in which the content is to be broadcast will have a significant impact on the viewers' experience. Such issues as which data compression techniques to use, how to allocate bandwidth between, for example, data and streaming video, and how to encapsulate and deliver the content must all be resolved before an IBN begins to function. And broadcast network service facilities built and maintained by broadcasters often lack significant functionality in the areas of security, content programming, media management, user management, monetization, and reporting. The broadcaster is thus not likely to end up with the best solution for its broadcast needs. Furthermore, the personal attributes that lead one to become a broadcaster of content are not necessarily coincident with the technical expertise and inclination to develop and support a broadcast network. Broadcasters who are not accustomed to synergizing diverse technical platforms, broadcast formats, and production facilities into a broadcast network often end up with a sub-optimum offering. Such sub-optimum offerings create dissatisfaction and frustration on the part of the viewers, the advertisers, and even the broadcasters themselves who desire to access the broadcast network. A viewer who experiences dissatisfaction and frustration when attempting to access a broadcast from a particular provider will be less likely to try to view a broadcast from that provider again. Losing viewers leads to losses of business and advertising revenue. Providers of financial support such as venture capital frown on broadcasters who have difficulties attracting and retaining customers. Thus, a broadcaster who neglects the technical aspects of a broadcast, even while providing a high level of substantive content, is likely to experience difficulties meeting its business goals. In addition, there are significant logistical and economic advantages to be gained by integrating standardized application tools, storage devices and streaming technologies and providing them to broadcasters on a bundled basis so the costs of their development and acquisition can be spread across several broadcasters' activities. Thus there exists a need in the art for an improved service capability to be provided to network broadcasters on a bundled basis.

### SUMMARY OF THE INVENTION

Techniques are provided for providing broadcast network services from a server by providing a broadcaster with access to a bundled collection of application tools, storage devices, and streaming media tools so the broadcaster can create, upload and/or store program files using the application tools, transmit the program file to its members for viewing as streaming media programming, and also allow the member to download auxiliary files associated with the program file, rate the content of the program file, and/or send communications to the broadcaster related to the program file.

One aspect of the invention involves providing broadcast network services from at least one server comprising the steps of a) providing a broadcaster with at least one application tool on said server, b) providing the broadcaster with a least one storage device accessible from the server, c) providing the broadcaster with at least one streaming media tool on the server, d) creating at least one program file with the application tool, e) uploading the program file to the server, f) storing the program file on the storage device, g) registering a prospective viewer as a member, h) allowing the member to create a member page on the server, i) providing the member with at least one downlink channel to view, j) associating the program file with the downlink channel, k) providing the member with a channel pass to browse the program files associated with the downlink channel, l) allowing the member to add at least one of the downlink channels to a favorites list on the member page, m) providing the member with a program pass to view at least one of the program files associated with the downlink channel, n) transmitting the program file to the member as streaming media with the streaming media tool, o) allowing the member to download auxiliary files associated with the program file, p) receiving the member's rating of the program file, q) allowing the member to add one of the program files to the favorites list on the member page, r) allowing the member to email the broadcaster of one of the programs.

Another aspect of the invention is a general broadcast network service provision apparatus to be provided to a broadcaster on a bundled basis, composed of a server with an operating system installed on the server, a database accessible to the server which is compatible with the operating system, an application tool installed on the server which is also compatible with the operating system, a streaming media tool installed on the server which is compatible with the operating system, a downlink channel from the server to a member, an uplink channel from the member to the server, and a plurality of program files stored in the database, associated with the downlink channel, wherein the broadcaster broadcasts a program file by i) creating at least one program file with the application tool, ii) uploading the program file to the server, iii) storing the program file in the database, iv) associating the program file with the downlink channel, and v) transmitting the program file to a member with the streaming media software; and wherein the member transmits a request to receive a program file to the server over the uplink channel by i) selecting a program file, ii) transmitting a request to view the selected program file over the uplink, and iii) viewing the selected program file; and wherein the server transmits the selected program file to the member over the downlink channel as streaming media by i) receiving a request to view the selected program file from the member, ii) retrieving the selected program file from the database, and iii) broadcasting the selected program file to the member as streaming media.

The above and other features and advantages of the present invention will be further understood from the following description of the preferred embodiments thereof, taken in conjunction with the accompanying drawings.

### BRIEF DESCRIPTION OF THE DRAWINGS

The present invention is illustrated by way of example, and not by way of limitation, in the figures of the accompanying drawings, in which like reference numerals refer to similar elements, and in which:

FIG. 1 shows a flow chart of the development of a custom built broadcast network service facility according to the conventional art.

FIG. 2 shows a layout of a broadcast network service provider according to an embodiment of the present invention.

FIG. 3 shows a flow chart of the development of a broadcast network service provider according to an embodiment of the present invention.

FIG. 4 shows a flow chart of the steps performed by a member participating in a network broadcast according to an embodiment of the present invention.

FIG. 5 shows a flow chart of the steps performed by a broadcaster administering a network broadcast according to an embodiment of the present invention.

FIG. 6 shows a flow chart of the program file development and customization process according to an embodiment of the present invention.

FIG. 7 shows a layout of a member interface according to an embodiment of the present invention.

FIG. 8 shows a layout of a broadcaster interface according to an embodiment of the present invention.

FIG. 9 shows a layout of the program file classification scheme.

FIG. 10 shows a computer system on which embodiments of the invention may be implemented.

### DETAILED DESCRIPTION OF THE PREFERRED EMBODIMENT

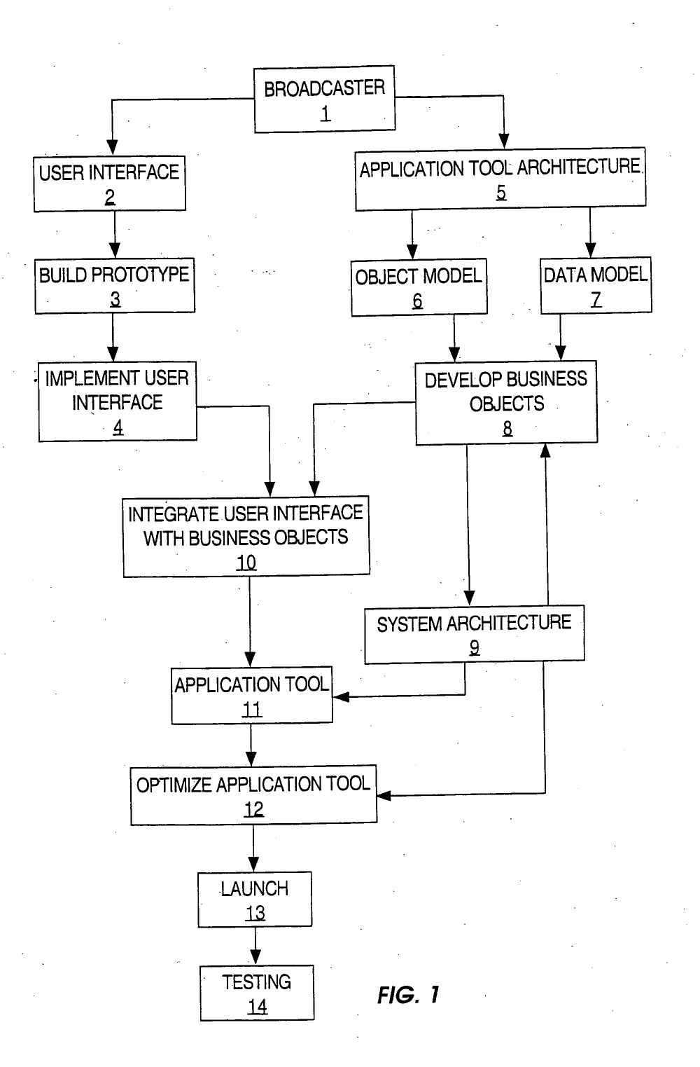

FIG. 1 shows the development of a conventional broadcast network service facility wherein a broadcaster 1 intending to broadcast streaming media over the internet designs a user interface 2, builds a prototype 3 of the user interface 2, and implements the user interface 4. The broadcaster 1 simultaneously acquires or designs the application tool architecture 5. The broadcaster 1 then formulates an object model 6 and a data model 7 for the application tool architecture 5, and develops business objects 8 around them. The business objects 8 are used to formulate the system architecture 9, and the system architecture 9 is also reflected in the business objects 8. The user interface 2 is integrated 10 with the business objects 8 to form an application tool 11. The application tool 11 is then optimized 12. Integration 10 and application tool optimization 12 both must be done within the limits of system architecture 9. The product may then be ready to launch 13. The launch 13 may entail further testing 14. The entire process typically may take up to nine months to complete.

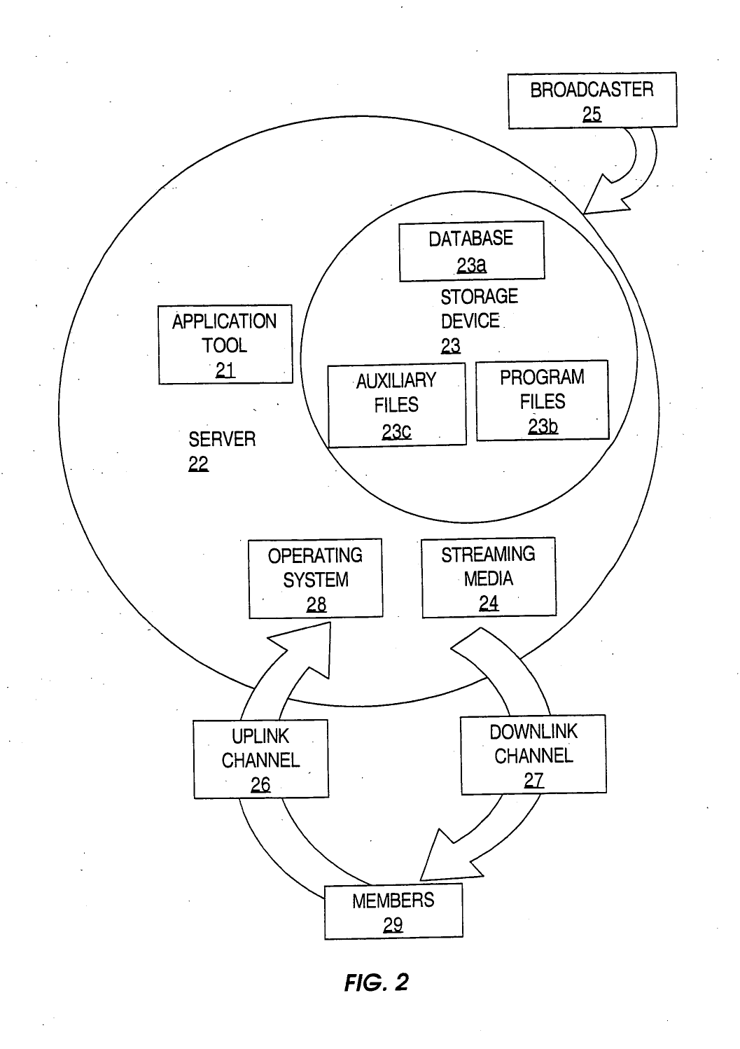

FIG. 2 shows a layout of the broadcast network service provider according to a preferred embodiment of the present invention. The broadcast network service facility hardware, including an operating system 28 running on a server or servers 22, application tool 21, storage devices 23 containing a database 23a of program files 23b and auxiliary files 23c, and streaming media software and/or hardware 24, has been integrated together and is available to the broadcaster 25 on a bundled basis. In a preferred embodiment application tool 21 is a broadcast producer tool. Program files 23b and auxiliary files 23c are uploaded and downloaded via uplink channel 26 and downlink channel 27 to members 29. Uplink channel 26 and downlink channel 27 may be implemented as the same physical device, as would be known to one skilled in the art. Uplink channel 26 and downlink channel 27 may also be implemented as a plurality of physical devices, and may comprise several alternative paths that the data may take between broadcaster 25 and members 29, as in the case of, for example, packet switched data. Program files 23b and auxiliary files 23c may be streamed directly from broadcaster 25 to members 29 from, for example, remote locations, without necessarily being stored on any given physical server 22. Database 23a and storage device 23 are thus meant to encompass distributed data storage schemes. The program files 23b and auxiliary files 23c may also be transmissions of live performances, including interactive performances. In the case of a live performance, for example, a program file may be stored for only nanoseconds before transmission without deviating from the spirit of the invention. And the database 23a and the storage device 23 further encompass volatile forms of memory, as well as non-electronic storage means such as chemical or optical images.

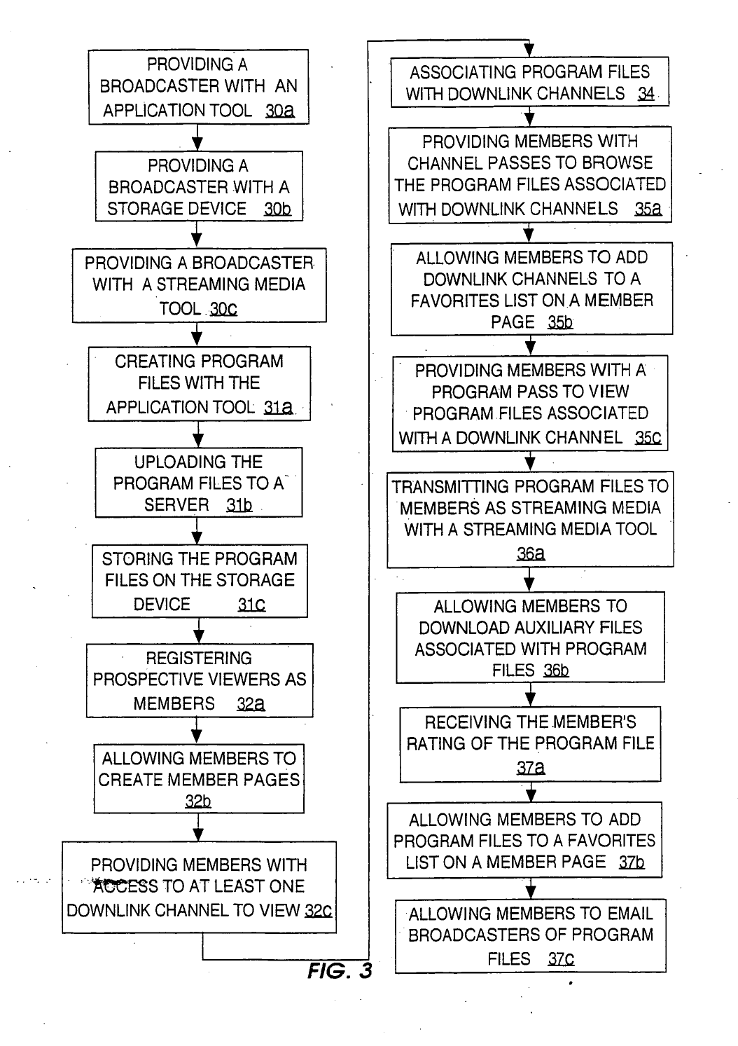

FIG. 3 shows a flow chart of the development of a broadcast network service provider according to a preferred embodiment of the present invention. In FIG. 3 the broadcaster is provided with an application tool on a server 30a, access to a storage device accessible from the server 30b, and streaming media tool in the form of either software or hardware 30c. The broadcaster uses the application tool to create program files 31a and upload them to the server 31b for storage 31c. The broadcaster registers prospective viewers as members 32a and may also allow the members to create a member page 32b. The broadcaster provides the members with a downlink channel to view 32c. Program files are associated with the downlink channel 34, and the members are provided with a channel pass to browse the program files associated with the downlink channel 35a. Members can add the downlink channels to a favorites list on their member page 35b. Members are provided with a program pass to view at least one of the program files associated with the downlink channel 35c, and the program file is transmitted to the member as streaming media with the streaming media tool 36a. Members might also be allowed to download auxiliary files associated with the program file 36b, rate the program file and send the rating to the broadcaster 37a, and add the program file to their favorites list on their member page 37b. The member may also email the broadcaster 37c. The application tool referred to in 30a may be a broadcaster producer tool. Registering prospective viewers as members 32a may include the steps of setting up an account for the member and receiving funds for that account on behalf of the member. The funds may be received via a credit card transaction, an electronic funds transfer, a PayPal transaction, or the like.

The member may be able to add at least one guest member when creating or updating their member page 32b. The member can browse programs associated with the downlink channel 35a by entering search terms to search the data base and viewing the results that are returned. The member's account is debited when the member is provided with a channel pass to browse the program files 35a. The member's account would also be debited when the member is provided with a program pass to view the program files 35c.

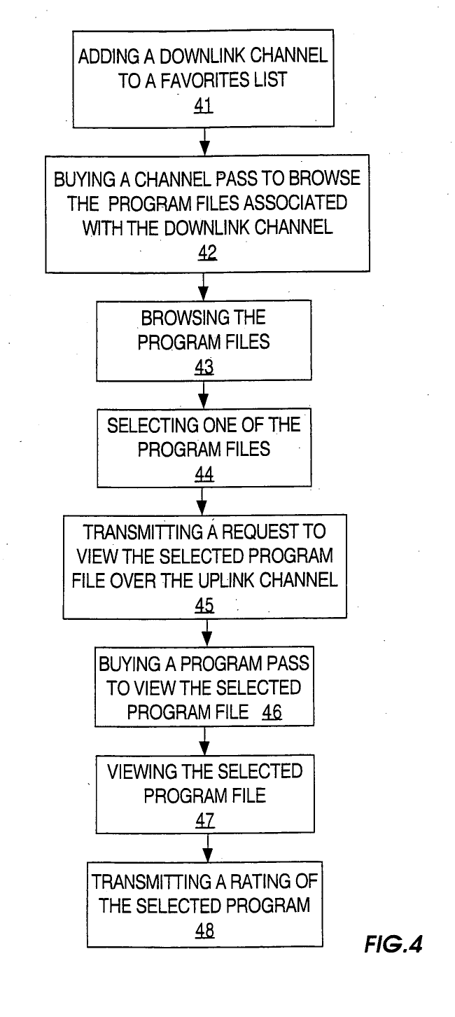

In FIG. 4 a member participates in a network broadcast by adding a downlink channel to a favorites list 41, buying a channel pass to browse program files associated with the downlink channel 42, browsing the program files 43, selecting one or more of the program files 44, transmitting a request to the broadcaster to view the program file over the uplink channel 45, buying a program pass to view the selected program file or files 46, viewing the program file 47, and rating the program file and sending the rating to the broadcaster 48.

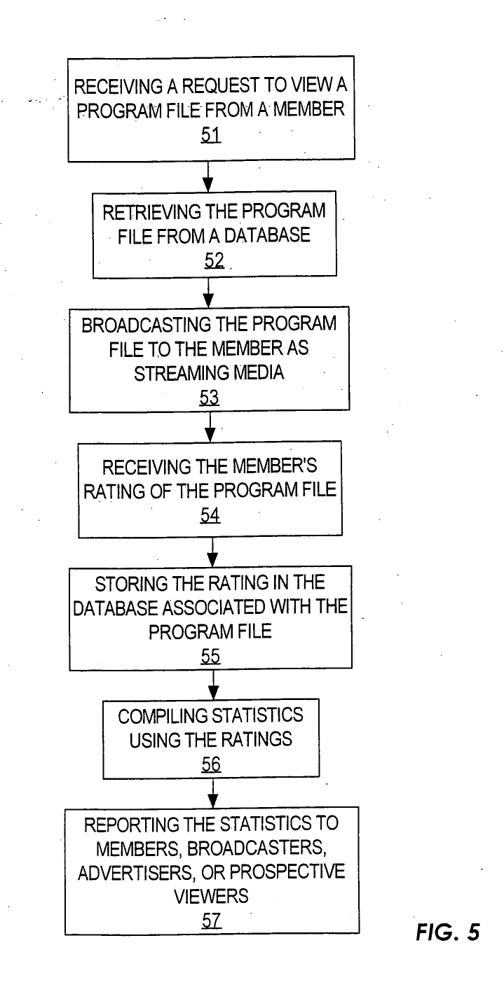

In FIG. 5 the broadcaster administers a network broadcast by receiving a request to view a program file from a member 51, retrieving the program file from the database 52, broadcasting the program file to the member as streaming media 53, receiving the member's rating of the program file 54, storing the rating in the database associated with the program file 55, compiling statistics using the ratings 56, and reporting the statistics to members, broadcasters, advertisers, or prospective viewers 57.

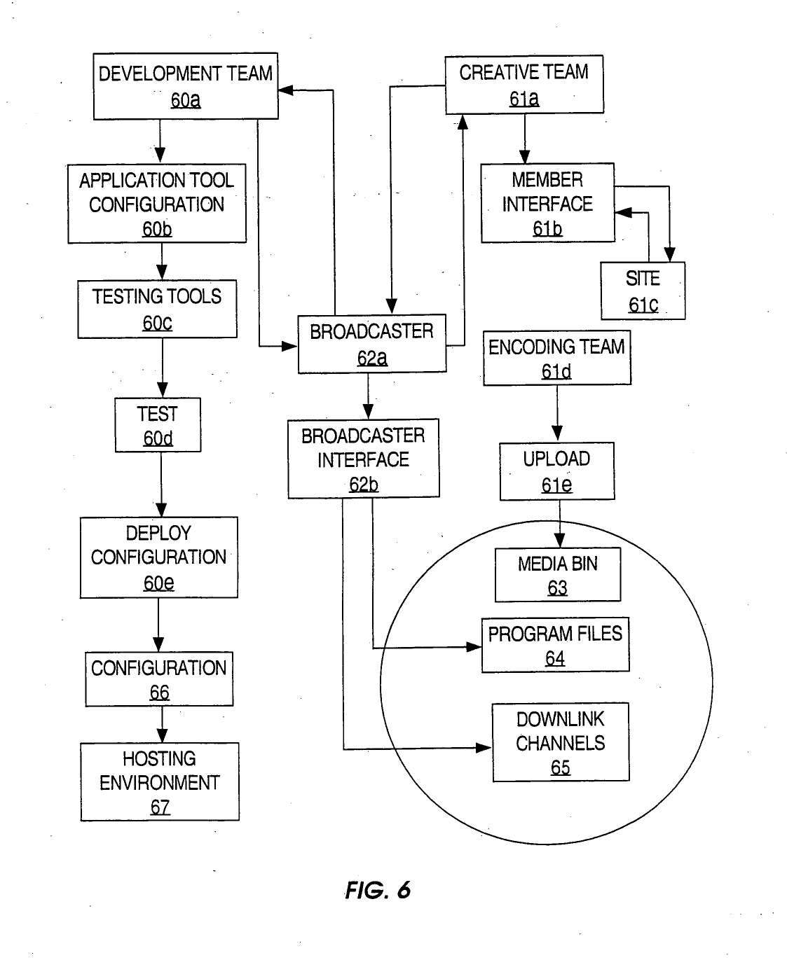

In FIG. 6 is shown the development of a network broadcasting service. In FIG. 6 the development team 60a configures 60b the application tool. The creative team 61a works with the broadcaster 62a to ensure the member interface 61b elements integrate seamlessly with a broadcaster's site 61c. The configuration 66 is tested rigorously 60d with both manual and automated testing tools 60c to ensure configuration reliability. The encoding team 61d converts the broadcaster's content into the desired streaming formats during the configuration process. The broadcaster's content is then uploaded 61e to the broadcaster's media bin 63 for content programming. Broadcasters 62a may use the broadcaster interface 62b to create downlink channels 65 and program files 64 themselves or work with programming consultants to create an initial program offering. When the broadcaster 62a is ready, the configuration 66 is deployed 60e in the hosting environment 67 without the need for costly hardware purchases or software licenses. After launch, the broadcaster 62a has continual password-protected access to the broadcaster interface 62b to make programming changes. Broadcasters 62a also have the option to change configuration 66 parameters as their business needs change. In addition, the broadcaster 62a will be able to include in their configuration 66 any or all of the new services that are developed, including syndication, live programs, and community services.

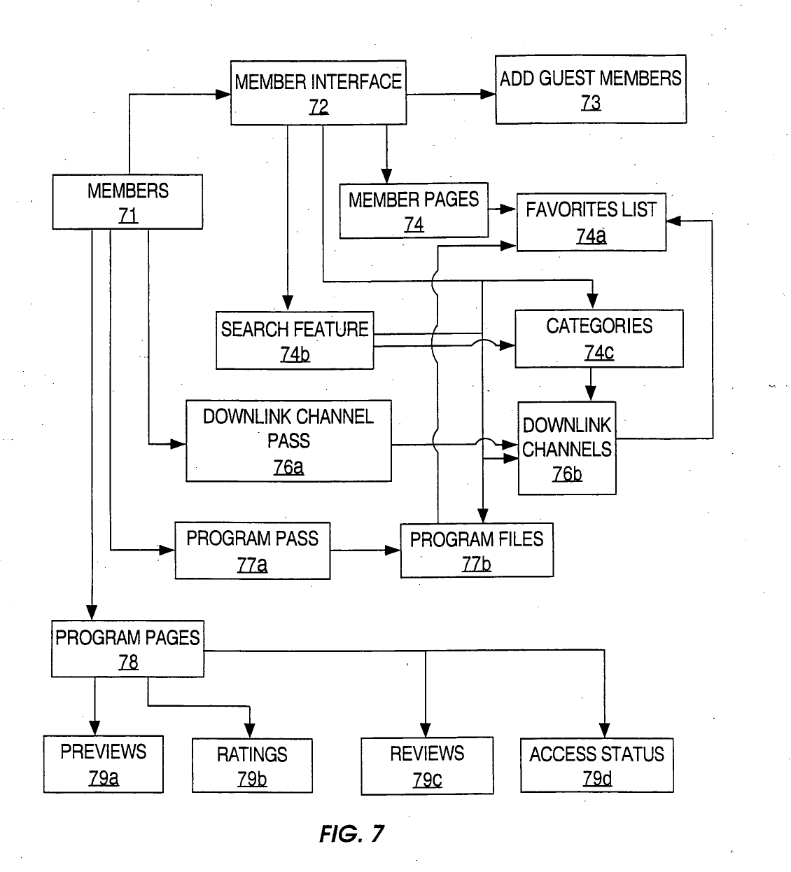

The member interface shown in FIG. 7 gives members 71 quick and easy access to content. Members 71 are drawn from the pool of prospective viewers. Members 71 use the member interface 72 to browse a hierarchy of categories 74c, downlink channels 76b, and program files 77b or use the versatile search feature 74b to find the content they need. Downlink channel 76b and program file pages 78 offer the member 71 detailed content information, including format, availability, price, and duration. Members 71 may watch a short preview 79a to help them make their choice. Also helpful are ratings 79b and reviews 79c written by other members 71. Members 71 can purchase a program pass 77a to gain access to an individual program file 77b for a limited time or they can buy a downlink channel pass 76a to gain access to a group of program files 77b on a subscription basis. When the member 71 is logged into the system, downlink channel 76b and program file pages 78 display member access status 79d, including the time left for any program pass 77a or downlink channel pass 76a. Members 71 can add guest members 73 under their membership.

Members 71 are able to personalize the tools they use to access the site. They can store a favorite program file 77b or downlink channel 76b for later reference on a favorites list 74a, send a link to a particular program file 77b or downlink channel 76b to a friend, or send an email to the broadcaster of the program file 77b over an uplink channel. When adding or editing a favorite program file 77b or downlink channel 76b, the member is also given the option of receiving email updates when a program file 77b or downlink channel 76b is updated by the broadcaster. Members can rate and review program files 77b and downlink channels 76b. Members may also communicate with broadcasters directly over the uplink channel to provide valuable feedback. Members can choose to reveal as little or as much of their identity and activities to other members or broadcasters as they wish. For a broadcaster site where community viewing is encouraged, members may maintain member pages 74 where they can display favorites, reviews and ratings, etc. More private members can keep their identities and biographical information visible to the application tool only.

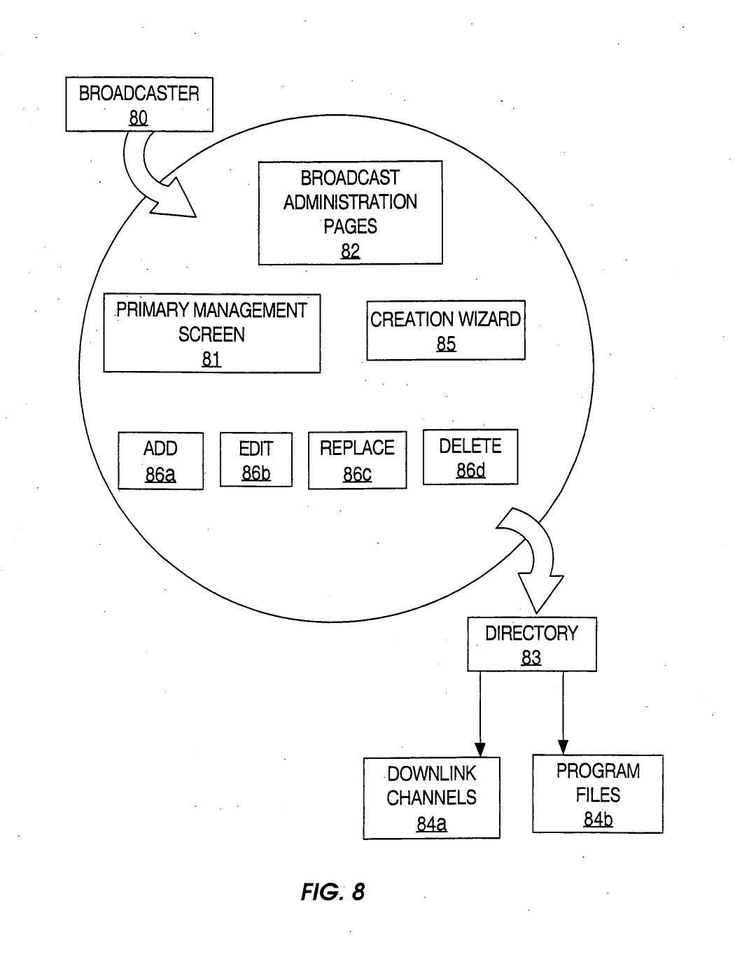

The broadcaster interface is shown in FIG. 8. Broadcasters access broadcast administration pages 82 through a login on the site. These administration pages 82 display only administrator functions that correspond with a broadcaster's application tool configuration parameters. The primary management screen 81 offers the broadcaster a directory 83 of the broadcaster's downlink channels 84a and program files 84b. From this interface, broadcasters can add new program files 86a, edit the attributes of existing program files 86b, replace program file content 86c, or delete program files 86d. Similar functions exist for uplink channel and downlink channel 84a management. In a preferred embodiment the uplink channel and the downlink channel are realized as the same physical device or devices. For broadcaster convenience, the application tool offers intuitive downlink channel 84a and program file 84b creation wizards 85 that guide broadcasters through their options, step-by-step.

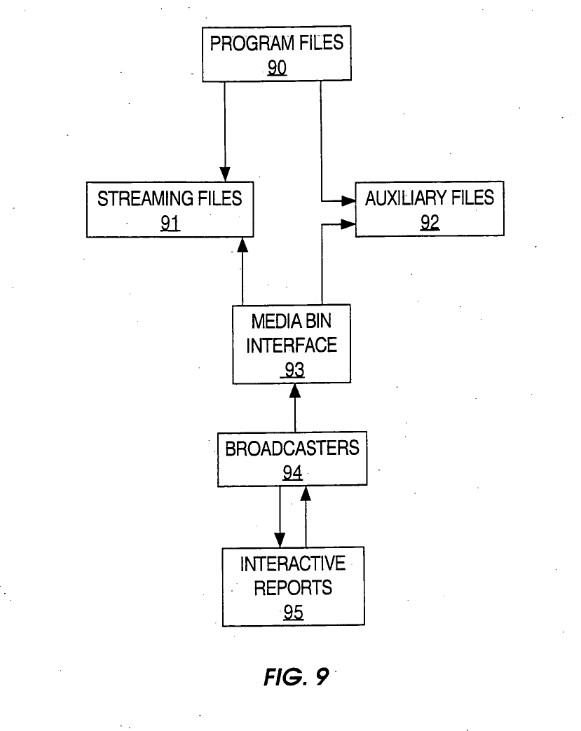

The application tool shown in FIG. 9 classifies program files 90 into two general categories: streaming files 91 and auxiliary files 92. Streaming files 91 can be of various types (e.g. video, audio, video with slides, etc.) and formats (e.g. Real, Windows, Quicktime, etc.). Auxiliary files 92 are files downloadable from a program file page that support or supplement the program file's 90 primary content. Broadcasters use the media bin interface 93 to manage these files. They can see an auxiliary file's 92 associated program files as well as watch the auxiliary file 92 directly. For convenience, broadcasters have the option to share some or all of their program files with other broadcasters. Broadcasters can also upload and download program files 90 using the media bin interface 93.

The application tool features interactive reports 95 presented to broadcasters online. A broadcaster sees information tailored for their downlink channels and program files 90. Reporting intervals are: month, week, and inter-day. Data for the monthly and weekly reports is updated daily except for the final monthly balance report, which is calculated at the month closing date. The inter-day reports collect up-to-the minute data for the current day. The application tool also supports multiple levels of broadcast administrators. Various privileges, such as the ability to add other broadcast administrators, can be restricted so that administrative roles map to roles within a broadcaster's organization.

The various services that make up domain administration are concerned with editorial control over a particular broadcast site. Using these services, a broadcaster can perform tasks such as select program files 90 for featured status, update copy that appears throughout the site, or edit system emails. User administration services allow the system administrator to manage users and their privileges within the application tool.

The application tool is built to function in an Application Service Provider (ASP) environment offering online services to large communities of broadcasters and partners.

There are two elements of the application tool—the Software Platform and Application Architecture. Streaming files are served by streaming servers directly from the file system. The application tool is highly configurable to work in an ASP environment and meet a wide range of broadcaster requirements. Configuration settings mostly affect the presentation tier (e.g. JHTML pages) and specially designed handlers, which are components sitting between the presentation and business logic tiers. The handlers decide which components to call to perform requested services based on the configuration parameters of a particular broadcaster. In addition to this, the handlers provide a security layer—if a broadcaster site is configured to exclude some features the corresponding services will not be called even if requested. The deployed application tool is partitioned into domains to accommodate new broadcasters. Different domains are completely independent even though they are hosted in the same application tool on the same servers using the same database. Rigid security is implemented to prevent content from one domain from being seen on another domain. Partitioning is used on the database and presentation tiers. On the database level there is logical data separation, where data for each domain is keyed by this domain code, thus preventing access by queries from other domains. On the presentation tier each broadcaster has a separate directory with custom pages. If a custom page does not exist then a corresponding common page will be served. In other words, besides configuring a feature set, a broadcaster has the option to customize a site by replacing some common pages with custom ones while using common pages for the rest of the site. In either case, requests from other domains will be rejected by the security system.

The application tool logic does not depend on what media formats are used (Real, Microsoft, QuickTime, etc.) and how the streams are delivered to members. The application tool has several components, which work as adapters for various formats and delivery methods. An adapter's task is simply to generate a proper link to a requested media file. The adapter components are lightweight; new components may be added quickly for new formats or delivery methods.

Security methods are implemented in all services dealing with sensitive information or rights management. The database uses encryption for all sensitive data. Sensitive data is never stored in open text form. Access to media files is protected by URL hiding so the location of a media file cannot be discovered by an end-user.

Broadcasters can select those services that are relevant to their particular streaming goals. For example, a broadcaster who wants to use streaming only for marketing purposes may not want the monetization service. If the broadcaster subsequently changes his mind and decides to charge for their content monetization can be added to their service.

The broadcaster can configure individual features within a service. For example, the monetization service could be configured to only allow subscriptions, or allow only certain payment methods.

Embodiments of the invention having been thus described, it will be apparent to those skilled in the art that the same may be varied in many ways without departing from the spirit and scope of the inventions. All such modifications are intended to be encompassed.

### HARDWARE OVERVIEW

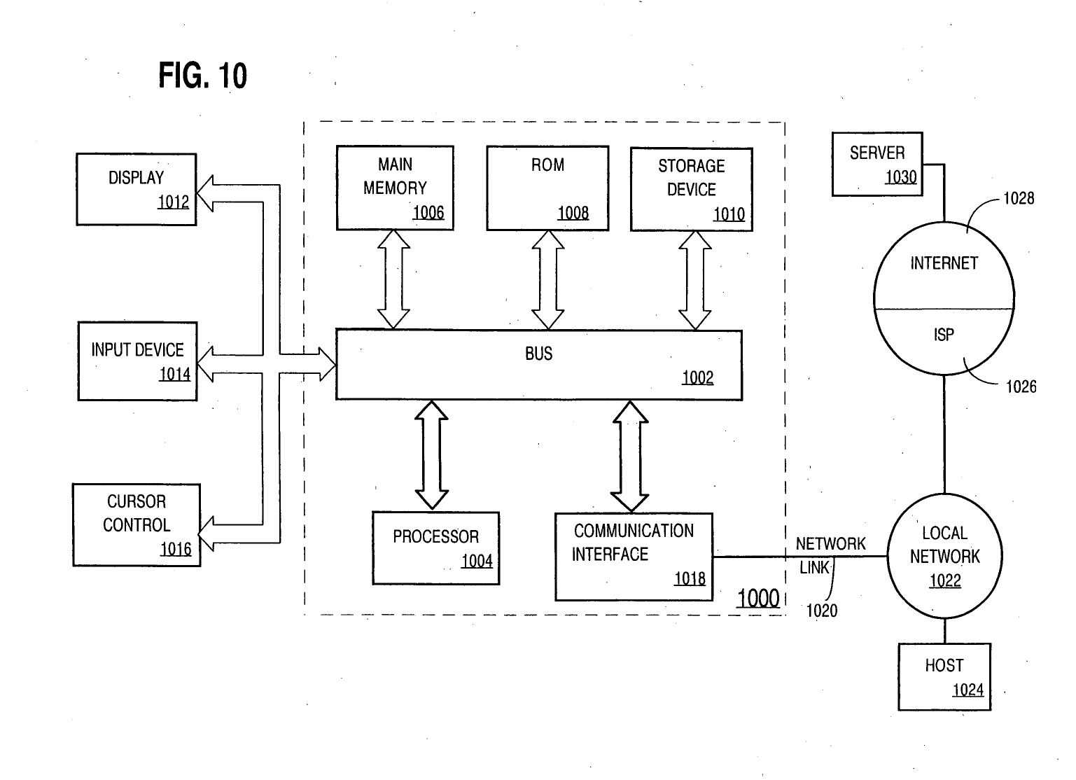

FIG. 10 is a block diagram that illustrates a computer system 1000 upon which an embodiment of the invention may be implemented. Computer system 1000 includes a bus 1002 or other communication mechanism for communicating information, and a processor 1004 coupled with bus 1002 for processing information. Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

The invention is related to the use of computer system 1000 for implementing the techniques described herein. According to one embodiment of the invention, those techniques are performed by computer system 1000 in response to processor 1004 executing one or more sequences of one or more instructions contained in main memory 1006. Such instructions may be read into main memory 1006 from another computer-readable medium, such as storage device 1010. Execution of the sequences of instructions contained in main memory 1006 causes processor 1004 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1004 for execution. Such a medium may take many forms, including but not limited to, non-volatile media, volatile media, and transmission media. Non-volatile media includes, for example, optical or magnetic disks, such as storage device 1010. Volatile media includes dynamic memory, such as main memory 1006. Transmission media includes coaxial cables, copper wire and fiber optics, including the wires that comprise bus 1002. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1004 for execution. For example, the instructions may initially be carried on a magnetic disk of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are exemplary forms of carrier waves transporting the information.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution. In this manner, computer system 1000 may obtain application code in the form of a carrier wave.

In the foregoing specification, the invention has been described with reference to specific embodiments thereof. It will, however, be evident that various modifications and changes may be made thereto without departing from the broader invention. The specification and drawings are, accordingly, to be regarded in an illustrative rather than a restrictive sense.

This listing of claims will replace all prior versions, and listings, of claims in the application:

1. A method for providing broadcast network services comprising the steps of:
a broadcaster obtaining a bundle that includes at least one application tool,
at least one storage device, and
at least one streaming media tool;
creating at least one program file with said application tool, wherein said at least one program file includes playable media content;
storing said program file on said storage device;
registering a prospective viewer as a member;
providing the member with at least one downlink channel to view;
associating said program file with said downlink channel; and
transmitting, for playback by said member, said program file over a computer network to said member as streaming media with said streaming media tool.

2. (canceled)

3. The method of claim 1, further comprising the step of providing said member with a channel pass to browse said program files associated with said downlink channel;
wherein the step of providing said member with a channel pass to browse said program files further comprises the step of debiting the account of said member; and
wherein the step of browsing programs associated with said downlink channel further comprises the steps of:
allowing said member to enter search terms;
searching said database of said program files using said search terms; and
returning results of said search to said member.

4-5. (canceled)

6. The method of claim 1, further comprising the step of:
providing said member with a program pass to view at least one of said program files associated with said downlink channel;
wherein the step of providing said member with a program pass to view said program file further comprises the step of debiting the account of said member.

7-8. (canceled)

9. The method of claim 1, further comprising the steps of:
allowing said member to create a member page;
wherein the step of allowing said member to create a member page further comprises the step of allowing said member to add at least one guest member;
allowing said member to add at least one of said downlink channels to a favorites list on said member page; and
allowing said member to add at least one of said program files to a favorites list on said member page.

10-12. (canceled)

13. The method of claim 1, further comprising the step of receiving said member's rating of said program file.

14. The method of claim 1, further comprising the step of allowing said member to email the broadcaster of at least one of said program files.

15. The method of claim 1, wherein the step of registering a prospective viewer as a member further comprises the steps of:
setting up an account for said member; and
receiving funds from said member for said account.

16-18. (canceled)

19. A broadcast network service provision system comprised of:
a broadcaster;
a server;
an operating system installed on said server;
a database accessible to said server, compatible with said operating system;
an application tool installed on said server, compatible with said operating system;
a streaming media tool installed on said server, compatible with said operating system;
at least one downlink channel from said server to at least one member;
an uplink channel from said member to said server;
a plurality of program files stored in said database, associated with said at least one downlink channel;
means for said broadcaster to broadcast at least one program file by:
i) creating at least one said program file with said application tool,
ii) uploading said program file to said server,
iii) storing said program file in said database,
iv) associating said program file with said downlink channel,
v) transmitting said program file to said member with said streaming media software; and
means for said member to transmit a request to receive a program file to said server over said uplink channel by:
i) selecting at least one of said program files,
ii) transmitting a request to view said selected program file over said uplink,
iii) viewing said selected program file; and
means for said server to transmit said selected program file to said member over said downlink channel as streaming media, by:
i) receiving a request to view said selected program file from said member,
ii) retrieving said selected program file from said database, and
iii) broadcasting said selected program file to said member as streaming media;
means for said member to add at least one of said downlink channels to a favorites list;
means for said member to buy a channel pass to browse program files associated with said downlink channel;
means for said member to browse said program files;
means for said member to buy a program pass to view said selected program file;
means for said member to transmit a rating of said selected program file over said uplink channel to said broadcaster;
means for said broadcaster to receive said member's rating of said selected program file;
means for said broadcaster to store said rating in said database associated with said program file;
means for said broadcaster to compile statistics using a plurality of said ratings; and
means for said broadcaster to report said statistics to another entity.

20-47. (canceled)

48. The method of claim 1, wherein the program file is a television program.

49. A method for providing broadcasting services, the method comprising:
bundling together, into a bundle, a collection of one or more application tools, one or more storage devices, and one or more streaming media tools; and
providing the bundle to a broadcaster;
wherein the one or more application tools can be used to create a program file;
wherein the one or more storage devices can be used to store the program file; and
wherein the one or more streaming media tools can be used to transmit the program file, over a computer network, from a server to a member.

50. The method of claim 49, wherein the one or more streaming media tools can be used to transmit the program file in a format that is one of Real, Windows, and Quicktime.
